(19) United States
(12) Patent Application Publication
(10) Pub. No.: US 2004/0129904 A1
(43) Pub. Date: Jul. 8, 2004

(54) Radiation image read-out apparatus

(75) Inventor: Takao Kuwabara, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/740,528

(22) Filed: Dec. 22, 2003

(30) Foreign Application Priority Data
Dec. 20, 2002 (JP) 370144/2002

(51) Int. Cl. G03B 42/08

(52) U.S. Cl. 250/585

(57) ABSTRACT

A radiation image read-out apparatus includes a stimulating light projecting system which projects stimulating light onto a radiation image convertor panel, a detecting system which detects stimulated emission emitted from the radiation image convertor panel upon exposure to the stimulating light, and a conveyor system which conveys the stimulating light projecting system relatively to the radiation image convertor panel. The stimulating light projecting system causes the stimulating light to impinge upon the surface of the radiation image convertor panel at an angle of incidence larger than 0° and smaller than 30° when the stimulating light projecting system is conveyed relatively to the radiation image convertor panel by the conveyor system.

### BACKGROUND OF THE INVENTION

1. Field of the Invention

This invention relates to a radiation image read-out apparatus, and more particularly to a radiation image read-out apparatus which detects stimulated emission emitted from a radiation image convertor panel upon exposure to stimulating light.

2. Description of the Related Art

When certain kinds of phosphors are exposed to radiation such as X-rays, they store a part of energy of the radiation. Then when the phosphors which have been exposed to the radiation is exposed to stimulating light such as visible light, light is emitted from the phosphors in proportion to the stored energy of the radiation. Phosphors exhibiting such properties are generally referred to as “stimulable phosphors”. In this specification, the light emitted from the stimulable phosphors upon stimulation thereof will be referred to as “stimulated emission”. There has been known as a CR (computed radiography) a radiation image recording and reproducing system, comprising a radiation image recording apparatus and a radiation image read-out apparatus, in which a layer of the stimulable phosphors is exposed to a radiation passing through an object such as a human body to have a radiation image of the object stored on the stimulable phosphor layer as a latent image, stimulating light such as a laser beam having a constant intensity is projected onto the stimulable phosphor layer, and the stimulated emission emitted from the stimulable phosphor layer is photoelectrically detected, thereby obtaining an image signal (a radiation image signal) representing a radiation image of the object. There has been known a radiation image convertor panel comprising a stimulable phosphor layer formed on a substrate as a recording medium employed in the radiation image recording and reproducing system.

As the radiation image read-out apparatus, there has been known an apparatus in which a stimulating light projecting system which comprises a laser and projects a line-like stimulating light beam extending in a main scanning direction and a detecting system which detects stimulated emission emitted from a radiation image convertor panel upon exposure to the stimulating light beam are integrated into a reading system, and the stimulated emission emitted from the radiation image convertor panel upon exposure to the stimulating light beam is detected at constant periods, that is, is detected at constant pitches in a sub-scanning direction perpendicular to the main scanning direction while the reading system is moved with respect to the radiation image convertor panel in the sub-scanning direction at a constant speed with the space between the reading section and the radiation image convertor panel kept constant, thereby obtaining an image signal representing a radiation image recorded on the radiation image convertor panel. Further, as disclosed, for instance, in Japanese Patent Publication No. 4 (1992)-68614, there have been known those in which the angle of incidence of the stimulating light beam to the surface of the radiation image convertor panel is 0° (i.e., the stimulating light beam impinges upon the surface of the radiation image convertor panel in perpendicular thereto) and those in which the angle of incidence of the stimulating light beam to the surface of the radiation image convertor panel is not smaller than 30° and not larger than 60°.

However, there is sometimes unevenness and/or swelling on the surface of the radiation image convertor panel for reasons of production, and the position of the reading system can sometimes fluctuate during the movement thereof in a direction perpendicular to the radiation image convertor panel. When the stimulating light obliquely impinges upon the surface of the radiation image convertor panel at an angle thereto, fluctuation in the space between the reading system and the radiation image convertor panel due to the above factors can cause unevenness in the detecting pitches described above.

That is, even if the reading system including the stimulating light projecting system moves in the sub-scanning direction at a constant speed, the stimulating light beam Le impinges upon the surface of the radiation image convertor panel 10 in a position Pa when the space between the radiation image convertor panel 10 and the stimulating light projecting system 20 is Wa, whereas the stimulating light beam Le impinges upon the surface of the radiation image convertor panel 10 in a position Pb which is nearer in the sub-scanning direction Y than the position Pa to the stimulating light projecting system 20 when the space between the radiation image convertor panel 10 and the stimulating light projecting system 20 is Wb smaller than said Wa, as shown in FIG. 4. Accordingly, if the space between the radiation image convertor panel 10 and the stimulating light projecting system 20 fluctuates, the positions in which the stimulating light beam Le impinges upon the radiation image convertor panel 10 move toward or away from the stimulating light projecting system in the sub-scanning direction, which causes the positions in which the stimulating light beam Le impinges upon the radiation image convertor panel 10 to be zigzagged and causes unevenness in the detecting pitches. The unevenness in the detecting pitches can deteriorate the quality of an image signal obtained by detection of the stimulated emission, which deteriorates the quality of an image displayed on the basis of the image signal.

In order to overcome this problem, it is preferred that the angle of incidence of the stimulating light to the radiation image convertor panel be minimized, that is, the stimulating light impinges upon the radiation image convertor panel at an angle close to 90°. However, if the stimulating light impinges upon the radiation image convertor panel in perpendicular thereto, a part of the stimulating light reflected by the radiation image convertor panel can return to the laser and disturb the circuit which stabilizes the output of the laser. When the output of the laser is unstable and the intensity of the stimulating light is unstable, the quality of an image signal obtained by detection of the stimulated emission can deteriorate, which deteriorates the quality of an image displayed on the basis of the image signal.

The problem of unevenness in the detecting pitches due to fluctuation in the space between the stimulating light projecting system and the radiation image convertor panel can occur irrespective of the system of projecting the stimulating light so long as the stimulating light obliquely impinges upon the radiation image convertor panel. For example, the problem occurs in common in a so-called line-beam system radiation image read-out apparatus where a line-like stimulating light beam is projected onto the radiation image convertor panel and the stimulated emission emitted from the radiation image convertor panel upon exposure to the line-like stimulating light beam is detected by a line sensor and a so-called point-scan system radiation image read-out apparatus where a spot-like stimulating light beam is caused to scan the radiation image convertor panel in the main scanning direction, for instance, by a polygonal scanner, and stimulated emission emitted from the radiation image convertor panel in a time series upon exposure to the spot-like stimulating light beam is detected by a photomultiplier through a light guide.

### SUMMARY OF THE INVENTION

In view of the foregoing observations and description, the primary object of the present invention is to provide a radiation image read-out apparatus which can suppress deterioration of the image signal obtained by detecting the stimulated emission emitted from a radiation image convertor panel upon exposure to stimulating light.

The radiation image read-out apparatus in accordance with the present invention comprises a stimulating light projecting means which projects stimulating light onto a radiation image convertor panel, a detecting means which detects stimulated emission emitted from the radiation image convertor panel upon exposure to the stimulating light, and a moving means which moves the stimulating light projecting means relatively to the radiation image convertor panel, wherein the improvement comprises that

the stimulating light projecting means causes the stimulating light to impinge upon the surface of the radiation image convertor panel at an angle of incidence larger than 0° and smaller than 30° when the stimulating light projecting means is moved relatively to the radiation image convertor panel by the moving means.

Preferably, the angle of incidence is larger than 2° and smaller than 30°.

The stimulating light projecting means may comprise a line source which emits a line-like stimulating light beam, and the detecting means may comprise a line sensor which detects the stimulated emission emitted from the line-like area of the radiation image convertor panel exposed to the line-like stimulating light beam.

The angle of incidence means that as measured to a virtual flat surface approximating the surface of the radiation image convertor panel upon which the stimulating light impinges upon.

The expression “moves the stimulating light projecting means relatively to the radiation image convertor panel” includes both a case where one of the radiation image convertor panel and the stimulating light projecting means is moved with the other kept stationary and a case where they are both moved.

In the radiation image read-out apparatus of the present invention, since the stimulating light projecting means causes the stimulating light to impinge upon the surface of the radiation image convertor panel at an angle of incidence smaller than 30° when the stimulating light projecting means is moved relatively to the radiation image convertor panel, fluctuation of the positions, in which the stimulating light beam impinges upon the radiation image convertor panel, in the direction of movement of the stimulating light projecting means can be suppressed, whereby unevenness in the detecting pitches when the stimulated emission is detected can be suppressed. Further, since the stimulating light does not impinge upon the radiation image convertor panel at an angle of incidence of 0°, i.e., in perpendicular to the radiation image convertor panel, the amount of stimulating light returning to the light source of the stimulating light projecting means from the radiation image convertor panel can be reduced as compared with when the stimulating light impinges upon the radiation image convertor panel in perpendicular thereto. Accordingly, in the case where the light source of the stimulating light projecting means is a laser, fluctuation of the output of the laser due to the returning light can be suppressed.

That is, by causing the stimulating light to impinge upon the surface of the radiation image convertor panel at an angle of incidence larger than 0° and smaller than 30°, the image signal obtained by detection of the stimulated emission can be of a quality which gives rise to substantially no problem.

Further, by causing the stimulating light to impinge upon the surface of the radiation image convertor panel at an angle of incidence larger than 2° and smaller than 30°, the amount of the returning stimulating light can be further reduced and deterioration of the quality of the image signal obtained by detection of the stimulated emission can be further suppressed.

### BRIEF DESCRIPTION OF THE DRAWINGS

FIG. 1 is a perspective view showing a radiation image read-out apparatus in accordance with an embodiment of the present invention,

FIG. 2 is an enlarged side view showing the stimulating light projecting system and the detecting system,

FIG. 3 is a view showing ideal detecting pitches when detecting the stimulated emission from the radiation image convertor panel,

FIG. 4 is a view showing the relation between the spaces between the stimulating light projecting system and the radiation image convertor panel and the positions in which the stimulating light beam impinges upon the radiation image convertor panel,

FIG. 5 is a view for illustrating fluctuation in detecting pitches with fluctuation in the space between the stimulating light projecting system and the radiation image convertor panel,

FIG. 6 is a view for illustrating the degree of variability of the image signal obtained on the basis of detection of the stimulated emission emitted from the radiation image convertor panel upon exposure to the stimulating light versus the angle of incidence of the stimulating light, and

FIG. 7 is a view for illustrating the degree of variability of the image signal.

### DESCRIPTION OF THE PREFERRED EMBODIMENTS

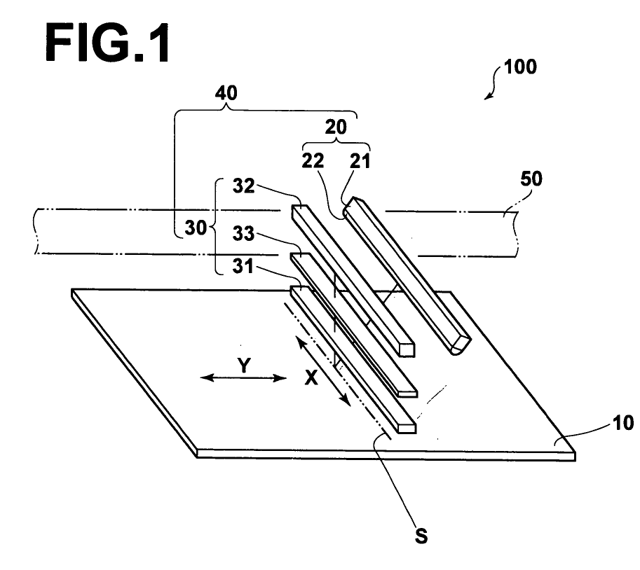

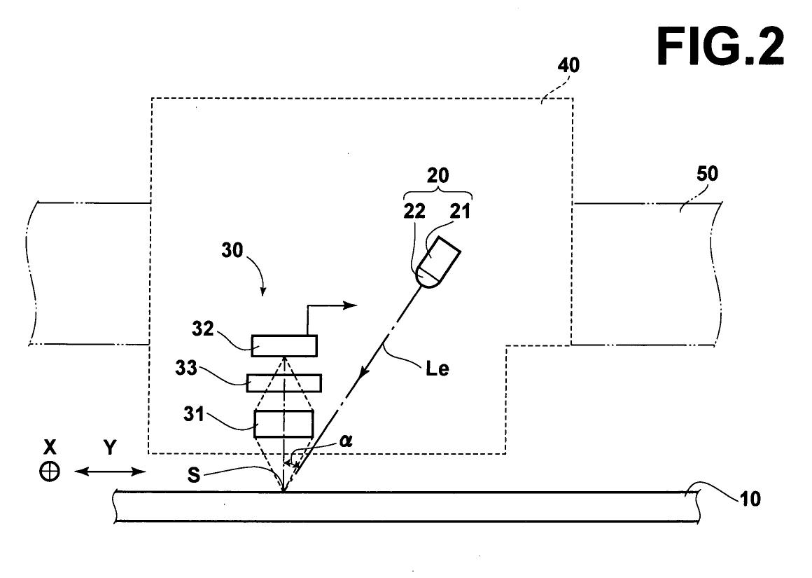

As shown in FIGS. 1 and 2, the radiation image read-out apparatus 100 in accordance with an embodiment of the present invention comprises a stimulating light beam projecting system 20 which projects a stimulating light beam Le onto a radiation image convertor panel 10 and a detecting system 30 which detects stimulated emission emitted from the radiation image convertor panel 10 upon exposure to the stimulating light beam Le, and a conveyor system 50 which moves the stimulating light projecting system 20 relatively to the radiation image convertor panel 10.

The stimulating light projecting system 20 causes the stimulating light Le to impinge upon the surface of the radiation image convertor panel 10 at an angle of incidence larger than 2° and smaller than 30° when the stimulating light projecting system 20 is moved relatively to the radiation image convertor panel 10 by the conveyor system 50. “The surface of the radiation image convertor panel 10” as mentioned here means a virtual flat surface approximating the surface of the radiation image convertor panel 10 upon which the stimulating light Le impinges upon and actually the surface of the radiation image convertor panel 10 is not flat but is provided with unevenness and/or swelling.

The stimulating light projecting system 20 comprises a stimulating light source 21 which is formed by a plurality of semiconductor lasers arranged in the main scanning direction X, a condenser optical system 22 comprising, for instance, a cylindrical lens which extends in the main scanning direction X and converges the stimulating light beam Le in a line-like area S on the radiation image convertor panel 10.

The detecting system 30 comprises an imaging lens system 31 formed by, for instance, a plurality of refractive index profile type lenses arranged in the main scanning direction X, a stimulating light cut filter 33 which transmits the stimulated emission but cuts the stimulating light and a line sensor 32 comprises a number of light receiving portions (e.g., CCDs) arranged in the main scanning direction X. These elements are arranged in this order toward the radiation image convertor panel 10.

The stimulating light projecting system 20 and the detecting system 30 are integrated into a reading system 40, which is conveyed at a constant speed in the sub-scanning direction Y (shown by arrow Y in FIGS. 1 and 2) perpendicular to the main scanning direction X by the conveyor means 50.

Operation of the radiation image read-out apparatus 100 in accordance with this embodiment will be described, hereinbelow.

A stimulating light beam Le emitted from the stimulating light projecting system 20 is converged in a line-like area S on the radiation image convertor panel 10. The stimulated emission emitted from the line-like area S of the radiation image convertor panel 10 upon exposure to the stimulating light beam Le is imaged on the line sensor 32 through the imaging lens system 31 and the stimulating light cut filter 33 and is photoelectrically converted to be output as an electric image signal representing the radiation image from the detecting system 30.

While projecting the stimulating light beam Le and detecting the stimulated emission, the reading system 40 into which the stimulating light projecting system 20 and the detecting system 30 are integrated is conveyed by said conveyor means 50 in the sub-scanning direction Y, whereby image signal components making up an image signal representing an image recorded on the radiation image convertor panel 10 are detected by the detecting system 30 at predetermined intervals.

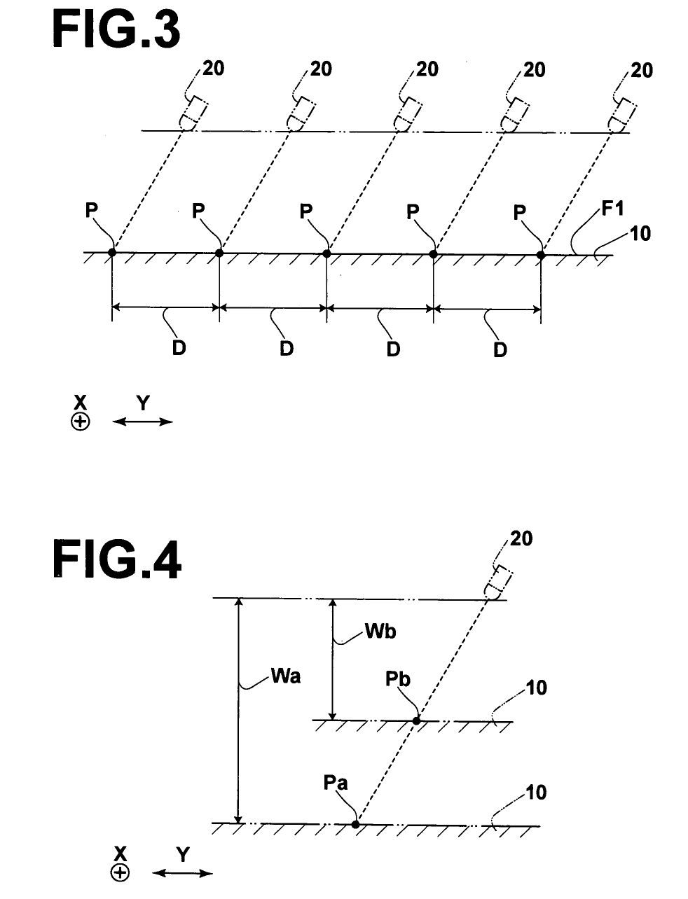

If the reading system 40 is conveyed by the conveyor means 50 with the space between the stimulating light projecting system 20 and the radiation image convertor panel 10 kept constant and the surface 10A (FIG. 3) upon which the stimulating light beam Le impinges upon is an ideal flat surface, the change in the sub-scanning direction of the impinging positions P in which the stimulating light beam Le impinges upon the radiation image convertor panel 10 is constant, that is, the detecting pitches D are constant as shown in FIG. 3.

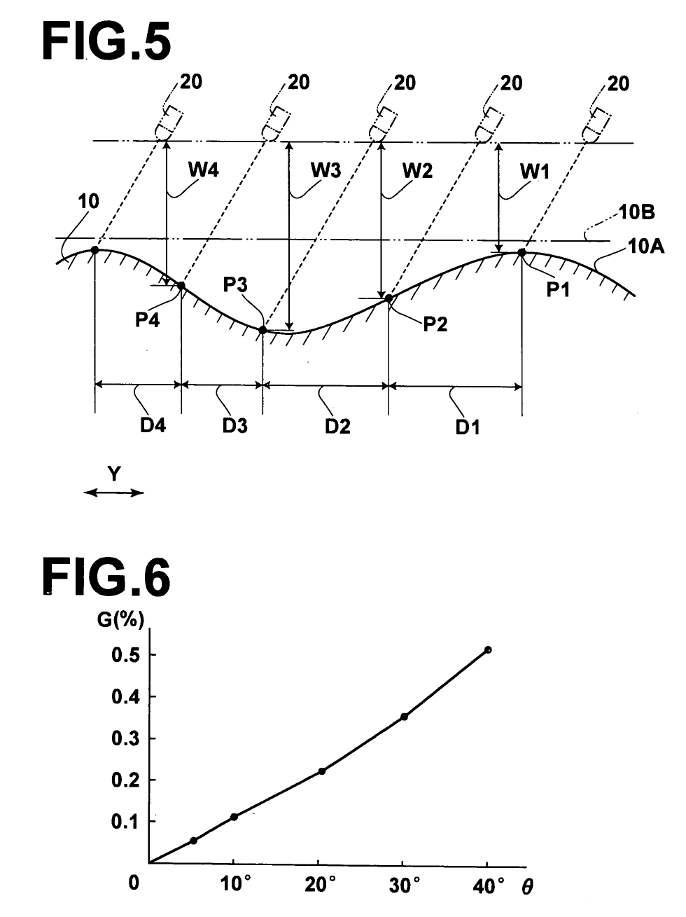

However, the change in the sub-scanning direction of the positions P in which the stimulating light beam Le impinges upon the radiation image convertor panel 10 depends upon the space between the stimulating light projecting system 20 and the radiation image convertor panel 10 as described above in conjunction with FIG. 4. Accordingly, if the space between the surface 10A and the stimulating light projecting system 20 fluctuates as indicated at W1, W2, W3 and W4 in FIG. 5, the impinging positions P1, P2, P3 and P4 shift in the sub-scanning direction Y toward and away from the stimulating light projecting system 20, whereby the stimulating light beam projecting pitches fluctuate as indicated at D1, D2, D3 and D4 in FIG. 5. The stimulating light beam projecting pitches correspond to the detecting pitches D, and unevenness of the detecting pitches D in the sub-scanning direction Y appears in the image signal obtained by detection of the stimulated emission emitted from the radiation image convertor panel 10.

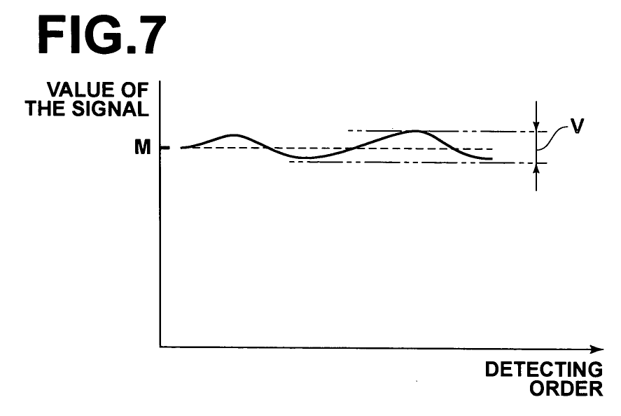

By reducing the angle of incidence at which the stimulating light beam Le impinges upon the surface 10A (more strictly, the virtual flat surface 10B approximating the surface 10A of the radiation image convertor panel 10), the unevenness of the detecting pitches D in the sub-scanning direction Y can be suppressed. For example, assuming that the reading system 40 is conveyed in the sub-scanning direction Y at a constant speed with the level of the reading system 40 in the direction perpendicular to the sub-scanning direction Y kept constant by the conveyor means 50 and the real surface 10A of the radiation image convertor panel 10 has periodic swellings which are 1 mm in period and 1 μm in amplitude (that is, the real surface 10A is protruded and recessed at regular intervals of 1 mm with a maximum difference in height of 1 μm), the degree of variability G of the image signal decreases with decrease in the angle of incidence θ of the stimulating light beam to the virtual surface 10B of the radiation image convertor panel 10 as shown in FIG. 6. When the degree of variability G of the image signal is not higher than 0.36% or when the angle of incidence θ is smaller than 30°, deterioration in image quality due to unevenness of the detecting pitches cannot be visually recognized in an image reproduced on the basis of the image signal obtained from the detected stimulated emission. The degree of variability G of the image signal as used here is defined as follows. That is, the radiation image convertor panel is exposed in solid to the radiation. Then the reading head 40 is moved along the radiation image convertor panel exposed in solid to the radiation to detect the stimulated emission emitted from the radiation image convertor panel, thereby obtaining an image signal. The degree of variability G of the image signal is defined to be a ratio of a maximum varying width V over which the values of the image signal vary to the average M of the values represented by the image signal. See FIG. 7 (the values of the image signal are plotted in the detecting order in FIG. 7). That is, the degree of variability G of the image signal=maximum varying width V/the average M of the values represented by the image signal.

The degrees of variability G of the image signal for several angles of incidence θ are listed in the following table.

TABLE

| | | | | | |
|---|---|---|---|---|---|
| θ (°) | 5 | 10 | 20 | 30 | 40 |
| G(%) | 0.07 | 0.13 | 0.23 | 0.36 | 0.52 |

When the angle of incidence θ is larger than 0° (preferably 2°), influence of the returning stimulating light reflected by the surface of the radiation image convertor panel 10 can be suppressed, whereby deterioration of the quality of the image signal obtained can be further suppressed.

Though, in the embodiment described above, the stimulated emission is detected by moving the stimulating light projecting system, the stimulated emission may be detected by moving the radiation image convertor panel with the stimulating light projecting system kept stationary or by moving both the radiation image convertor panel and the stimulating light projecting system.

Suppression of unevenness in the detecting pitches by causing the stimulating light to impinge upon the surface of the radiation image convertor panel at an angle of incidence larger than 2° and smaller than 30° can be applied to both a so-called line-beam system radiation image read-out apparatus where the stimulated emission emitted from the radiation image convertor panel upon exposure to the line-like stimulating light beam is detected by a line sensor and a so-called point-scan system radiation image read-out apparatus where a spot-like stimulating light beam is caused to scan the radiation image convertor panel in the main scanning direction, for instance, by a polygonal scanner, and stimulated emission emitted from the radiation image convertor panel in a time series upon exposure to the spot-like stimulating light beam is detected by a photomultiplier through a light guide.

What is claimed is:

1. The radiation image read-out apparatus comprising a stimulating light projecting means which projects stimulating light onto a radiation image convertor panel, a detecting means which detects stimulated emission emitted from the radiation image convertor panel upon exposure to the stimulating light, and a moving means which moves the stimulating light projecting means relatively to the radiation image convertor panel, wherein the improvement comprises that
the stimulating light projecting means causes the stimulating light to impinge upon the surface of the radiation image convertor panel at an angle of incidence larger than 0° and smaller than 30° when the stimulating light projecting means is moved relatively to the radiation image convertor panel by the moving means.

2. A radiation image read-out apparatus as defined in claim 1 in which the angle of incidence is larger than 2° and smaller than 30°.

3. A radiation image read-out apparatus as defined in claim 1 in which the stimulating light projecting means comprises a line source which emits a line-like stimulating light beam, and the detecting means comprises a line sensor which detects the stimulated emission emitted from the line-like area of the radiation image convertor panel exposed to the line-like stimulating light beam.
